(19) United States
(12) Patent Application Publication
(10) Pub. No.: US 2026/0218754 A1
(43) Pub. Date: Jul. 30, 2026

(54) ROLLING BEARING

(71) Applicant: NAKANISHI METAL WORKS CO., LTD., Osaka-shi, Osaka (JP)

(72) Inventors: Yasuhiko KOJIMA, Osaka-shi (JP); Nao SHIMAZAKI, Osaka-shi (JP)

(73) Assignee: NAKANISHI METAL WORKS CO., LTD., Osaka-shi, Osaka (JP)

(21) Appl. No.: 19/148,877

(22) PCT Filed: Dec. 13, 2023
(86) PCT No.: PCT/JP2023/044714

§ 371 Date: Jul. 17, 2025

(30) Foreign Application Priority Data
Feb. 9, 2023 (JP) 2023-018626

(51) Int. Cl. F16C 33/78; F16C 19/06; F16C 33/66

(52) U.S. Cl. CPC F16C 33/7843; F16C 19/06; F16C 33/6688

(57) ABSTRACT

A rolling bearing includes an inner ring; an outer ring; rolling elements interposed between the inner ring and the outer ring; and an elastic member provided in at least one of openings on both ends in an axial direction of the inner ring and the outer ring, and seals a lubricant around each of the rolling elements. The lubricant is one of a silicone oil-based lubricant and a mineral oil-based lubricant, and the elastic member is a vulcanizate of a rubber composition containing epichlorohydrin rubber, a dispersion improver, a reinforcing material, and modified clay.

### TECHNICAL FIELD

The present invention relates to a rolling bearing, and particularly to a rolling bearing including an elastic member in which epichlorohydrin rubber is used.

### BACKGROUND ART

In general, a rolling bearing has an inner ring, an outer ring, and rolling elements interposed between the inner ring and the outer ring, and has a lubricant sealed therein in order to impart lubricity to them. In order to prevent the lubricant from leaking through an opening between the inner ring and the outer ring, a member having an elastic member for sealing the opening is provided as a bearing seal. The elastic member usually comes into contact with the lubricant while sliding relative to the inner ring or the outer ring, and thus is required to have wear resistance and durability to the lubricant.

In order to satisfy performance required for such an elastic member, rubber components such as nitrile rubber (NBR), acrylic rubber (ACM), ethylene-acrylic rubber (AEM), fluororubber (FKM), and silicone rubber (VMQ) have been conventionally used as a material of the elastic member used for the bearing seal. Improvement has been repeated according to the usage of the rolling bearing in order to, for example, enhance the performance.

Meanwhile, in epichlorohydrin rubber, it is known that characteristics such as mechanical strength, heat resistance, low-temperature resistance (cold resistance), ozone resistance, gas permeability, flame retardancy, and oil resistance are good in general, but wear resistance is not necessarily sufficient. Therefore, epichlorohydrin rubber is usually used as a hose material as described in Patent Literature (PTL) 1, and is not practically used as, for example, a material of the elastic member used for sealing a lubricant for a rolling bearing of automobiles and the like, under the current circumstances.

### CITATION LIST

### Patent Literature

[PTL 1] Japanese Published Examined Application No. S60-33663

### SUMMARY OF THE INVENTION

### Problems to be Solved by the Invention

The inventors of the present invention have focused on the above-described good characteristics of epichlorohydrin rubber, and have attempted to use epichlorohydrin rubber as a rubber component for an elastic member in a rolling bearing. However, it has been found that, when an ester oil-based lubricant including ester oil is adopted as a base oil, volume change and hardness change of the elastic member are large. For example, (i) the large volume change causes unstable seal interference, and (ii) reduction of hardness or another reason causes the elastic member to be softened, to increase a contact area between the elastic member and a bearing ring (race) formed of the inner ring and the outer ring, causing abnormal wear to occur, or reducing tightening force. Therefore, it was difficult to adopt epichlorohydrin rubber as the rubber component of the elastic member of a rolling bearing.

An object of the present invention is to provide a rolling bearing that can reduce volume change and hardness change due to sealing of a lubricant, and has good wear resistance and hardness, even in a case where a rubber component of an elastic member is epichlorohydrin rubber.

### Solution to the Problems

Inventors of the present invention have made a diligent study to solve the aforementioned problem. As a result, it has been found that when a silicone oil-based lubricant containing silicone oil or a mineral oil-based lubricant containing mineral oil is used as a base oil, the aforementioned problem can be solved by adopting epichlorohydrin rubber as a rubber component and containing a dispersion improver, a reinforcing material, and modified clay. The present invention has the following gist.

The present invention is directed to a rolling bearing that includes an inner ring; an outer ring; rolling elements interposed between the inner ring and the outer ring; and an elastic member provided in at least one of openings on both ends in an axial direction of the inner ring and the outer ring, and seals a lubricant around each of the rolling elements. The lubricant is one of a silicone oil-based lubricant and a mineral oil-based lubricant, and the elastic member is a vulcanizate of a rubber composition containing epichlorohydrin rubber, a dispersion improver, a reinforcing material, and modified clay.

According to an embodiment of the present invention, the rubber composition contains 1.0 to 3.0 parts by weight of the dispersion improver, 25 to 35 parts by weight of the reinforcing material, and 40 to 80 parts by weight of the modified clay, with respect to 100 parts by weight of the epichlorohydrin rubber.

According to an embodiment of the present invention, the dispersion improver is a coupling agent.

According to an embodiment of the present invention, the reinforcing material is silica.

According to an embodiment of the present invention, the modified clay is silane-modified clay that is a surface-treated product obtained by performing surface treatment on clay with a silane-based coupling agent.

In the embodiments of the present invention, the configurations of the above-described embodiments can be discretionarily combined.

### Advantageous Effects of the Invention

The present invention can provide a rolling bearing that can reduce volume change and hardness change due to sealing of a lubricant, and has good wear resistance and hardness, even in a case where the rubber component of the elastic member is epichlorohydrin rubber.

### BRIEF DESCRIPTION OF THE DRAWINGS

FIG. 1 is a cross-sectional view of a rolling bearing according to an embodiment of the present invention.

FIG. 2 is an enlarged cross-sectional view of a main portion in FIG. 1.

FIG. 3 illustrates a method for performing a wear resistance test.

### DESCRIPTION OF EMBODIMENTS

A rolling bearing according to an embodiment of the present invention includes an inner ring, an outer ring, rolling elements interposed between the inner ring and the outer ring, and an elastic member that is provided in at least one of openings on both ends in an axial direction of the inner ring and the outer ring, and seals a lubricant around each of the rolling elements. The lubricant is a silicone oil-based lubricant or a mineral oil-based lubricant. The elastic member is a vulcanizate of a rubber composition that contains epichlorohydrin rubber, a dispersion improver, a reinforcing material, and modified clay.

When a silicone oil-based lubricant or a mineral oil-based lubricant is used as the lubricant, an effect on the epichlorohydrin rubber is reduced, thereby reducing volume change and hardness change (especially decrease in hardness) of the elastic member, in comparison with a case where an ester oil-based lubricant is used. Furthermore, a dispersion improver is used in combination with a reinforcing material and modified clay, thereby enhancing dispersibility of the reinforcing material and the modified clay in the epichlorohydrin rubber. Therefore, mechanical strength such as tensile strength at break and tensile elongation at break, which utilizes good properties of the epichlorohydrin rubber, is provided, as well as abrasion resistance and hardness of the elastic member can be improved. Here, the hardness means Shore A hardness, which can be measured by a method described in the Examples described later.

Embodiments of the rubber composition to be used for the elastic member are described below.

As described above, the rubber composition contains epichlorohydrin rubber, a dispersion improver, a reinforcing material, and modified clay. In the rubber composition, a rubber component is the epichlorohydrin rubber. In other words, the rubber composition contains no rubber components other than epichlorohydrin rubber as the rubber component. Examples of the epichlorohydrin rubber include a homopolymer of epichlorohydrin (may be abbreviated as CO), a copolymer of epichlorohydrin and ethylene oxide (may be abbreviated as ECO), a copolymer of epichlorohydrin and allyl glycidyl ether (may be abbreviated as GCO), and a copolymer of epichlorohydrin, ethylene oxide, and allyl glycidyl ether (may be abbreviated as GECO). Any of them can be used. Among them, CO and ECO are preferable. Furthermore, as the epichlorohydrin, epichlorohydrin derived from a plant material can be used. By using such epichlorohydrin obtained from a material derived from a plant, the epichlorohydrin rubber can be an environmentally friendly rubber component. From the viewpoint of environment friendliness, epichlorohydrin derived from a plant material is preferably used, and a homopolymer (CO) of epichlorohydrin derived from a plant material is more preferably used. The content of the epichlorohydrin rubber in the rubber composition can be determined as appropriate according to, for example, usage of the rolling bearing, and can be, for example, 35 to 75 weight % in the entirety of the rubber composition.

The dispersion improver is not particularly limited as long as dispersibility of the reinforcing material and the modified clay in the epichlorohydrin rubber can be enhanced, and the dispersion improver can be selected as appropriate according to the kinds of the reinforcing material and a modifier. Examples of such a dispersion improver include a coupling agent and a surfactant. Among them, a coupling agent is preferable from the viewpoint of enhancing dispersibility and wear resistance. Examples of the coupling agent include a silane-based coupling agent such as a vinyl-based silane coupling agent, an amino-based silane coupling agent, an epoxy-based silane coupling agent, and a mercapto-based silane coupling agent, a zirconia-based coupling agent, a titanate-based coupling agent, and an aluminate-based coupling agent. Among them, the silane-based coupling agent is preferable, and the mercapto-based silane coupling agent is particularly preferable as the silane-based coupling agent. Examples of the mercapto-based silane coupling agent include a mercapto-based silane coupling agent in which 1 to 3 mercapto groups (—SH) or 1 to 3 functional groups containing mercapto groups bond directly to Si. Examples of the functional group containing a mercapto group include a C1 to C6 hydrocarbon group substituted with a mercapto group. The hydrocarbon group may be a saturated hydrocarbon group or an unsaturated hydrocarbon group, but a saturated hydrocarbon group is preferable. The structure of the hydrocarbon group may be linear or branched, but a linear structure is preferable. The silane-based coupling agent preferably has an alkoxy group, and examples of the alkoxy group include a methoxy group and an ethoxy group, and a methoxy group is more preferable. The number of the alkoxy groups may be any of 1 to 3. One kind of the dispersion improver may be used alone, or two or more kinds of the dispersion improvers may be used in combination.

The content of the dispersion improver in the rubber composition can be determined as appropriate according to the usage of the rolling bearing or the like. From the viewpoint of dispersibility and wear resistance, the content of the dispersion improver is preferably 0.5 to 5.0 parts by weight and more preferably 1.0 to 3.0 parts by weight with respect to 100 parts by weight of the epichlorohydrin rubber.

The reinforcing material is not particularly limited as long as it can enhance wear resistance and hardness of the elastic member, in combination with the modified clay. Examples of the reinforcing material include silica, calcium carbonate, barium sulfate, clay (excluding modified clay), fiber, an organic reinforcing agent, and an organic filler. One kind of the reinforcing material may be used alone, or two or more kinds of the reinforcing materials may be used in combination. Among the specific examples of the reinforcing materials, silica is particularly preferable. The silica should be silicon dioxide or a substance formed of silicon dioxide. Examples of the silica include wet silica, fumed silica, diatomaceous earth, and silicate such as magnesium silicate. Among them, silica is preferably silicon dioxide such as wet silica and fumed silica.

The content of the reinforcing material in the rubber composition can be determined as appropriate according to the usage of the rolling bearing or the like. From the viewpoint of wear resistance and enhancement of hardness of the elastic member, the content of the reinforcing material is preferably 15 to 40 parts by weight and more preferably 25 to 35 parts by weight with respect to 100 parts by weight of the epichlorohydrin rubber.

The modified clay is not particularly limited as long as it can enhance wear resistance and hardness of the elastic member, in combination with the reinforcing material. Examples of such modified clay include silane-modified clay. The silane-modified clay is preferably a product (surface-treated product) obtained by performing surface treatment on clay with a silane-based coupling agent. The clay used for the treatment can be, for example, calcined at 600° C. As such silane-modified clay, commercially available silane-modified clay can be used, and examples thereof include BURGESS KE manufactured by BURGESS.

The content of the modified clay in the rubber composition can be determined as appropriate according to the usage of the rolling bearing or the like. From the viewpoint of wear resistance and enhancement of hardness of the elastic member, the content of the modified clay is preferably 10 to 90 parts by weight and more preferably 40 to 80 parts by weight with respect to 100 parts by weight of the epichlorohydrin rubber.

Components other than the above-described components can be blended with the rubber composition. Examples of such components include a vulcanizing agent, a vulcanization accelerator, a stabilizer, an anti-aging agent, lubricating oil, a plasticizer, a softener, a coloring agent, a processing aid, and a scorch preventing agent.

Examples of the vulcanizing agent include: sulfur; quinoxaline-based vulcanizing agents such as 2,3-dimercaptoquinoxaline, quinoxaline-2,3-dithiocarbonate, 6-methylquinoxaline-2,3-dithiocarbonate, and 5,8-dimethylquinoxaline-2,3-dithiocarbonate; 2,4,6-trimercapto-s-triazine; thiurams such as tetramethylthiuram monosulfide (TMTS), tetramethylthiuram disulfide (TMTD), tetraethylthiuram disulfide (TETD), tetrabutylthiuram disulfide (TBTD), and dipentamethylenethiuram tetrasulfide (DPTT); and sulfur-based vulcanizing agents such as 4,4′-dithio-dimorpholine. One of them may be used alone, or two or more of them may be used in combination. The content of the vulcanizing agent is preferably 0.5 to 10 parts by weight with respect to 100 parts by weight of the epichlorohydrin rubber.

Examples of the vulcanization accelerator include guanidine compounds, imidazole compounds, a quaternary onium salt, tertiary amine compounds, tertiary phosphine compounds, and an alkali metal salt of a weak acid. Examples of the guanidine compound include 1,3-diphenylguanidine and 1,3-di-o-tolylguanidine. Examples of the imidazole compound include 2-methylimidazole and 2-phenylimidazole. Examples of the quaternary onium salt include tetra n-butylammonium bromide and octadecyltri n-butylammonium bromide. Examples of the tertiary amine compound include triethylenediamine and 1,8-diaza-bicyclo[5,4,0]undecene-7. Examples of the tertiary phosphine compound include triphenylphosphine and tri-p-tolylphosphine. Examples of an alkali metal salt of a weak acid include inorganic weak acid salts such as phosphate of sodium or potassium, and carbonate, and organic weak acid salts such as stearate and laurate. The content of the vulcanization accelerator is preferably 0.1 to 5 parts by weight with respect to 100 parts by weight of the epichlorohydrin rubber.

Examples of the stabilizer include magnesium oxide, hydrotalcites, zeolites, calcium oxide, aluminum oxide, basic silicon dioxide, and magnesium hydroxide. One of them may be used alone, or two or more of them may be used in combination.

The rubber composition can be obtained by mixing the above-described essential components and the other components to be used as necessary at a desired blending ratio, and uniformly kneading the mixed components. As the kneading method, a conventionally known method can be adopted. For example, a method for uniform kneading with use of a closed type kneader such as a kneader or a Banbury mixer, or an open type kneader such as a roll, is used.

The elastic member according to the embodiment can be, for example, obtained as a vulcanizate (molded product) of the rubber composition having a predetermined shape, by vulcanizing and molding the rubber composition obtained as described above at a predetermined temperature through a molding method such as compression molding, injection molding, transfer molding, extrusion molding, or calender molding.

In the elastic member obtained by vulcanizing the above-described rubber composition, the rubber component may be the epichlorohydrin rubber. Even with such a rubber component, if the lubricant sealed in the rolling bearing is a specific lubricant, the influence of the lubricant is reduced without impairing most of the good properties of the epichlorohydrin rubber itself. Even if such an elastic member is in contact with the specific lubricant, volume change and hardness change (in particular, decrease in hardness) are inhibited so as to exhibit good hardness, and the elastic member also has good wear resistance. Therefore, such an elastic member can be applied to various rolling bearings as long as the specific lubricant is used. For example, the elastic member is suitable for a rolling bearing for automobiles, which has an elastic member for sealing a silicone oil-based lubricant or a mineral oil-based lubricant for automobile electrical equipment and auxiliary equipment.

A rolling bearing according to an embodiment in which the above-described elastic member is used will be described below with reference to the drawings. In the following description, the rotation axis direction is referred to as “axial direction”, and the rotation radius direction is referred to as “radial direction”.

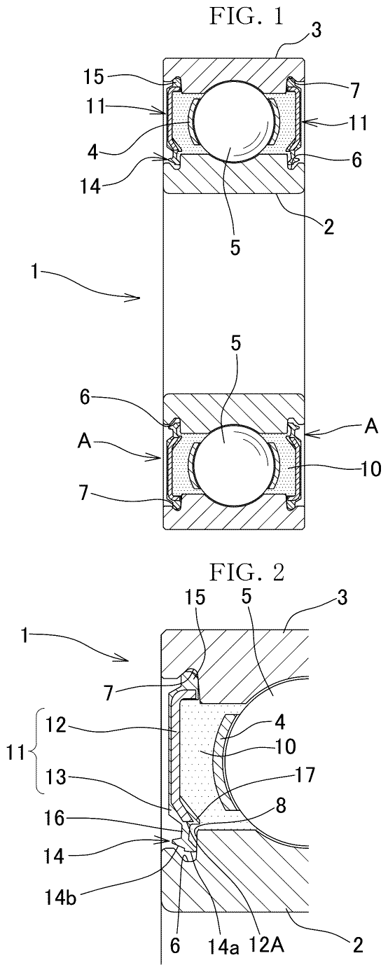

FIG. 1 and FIG. 2 show a rolling bearing 1 having a bearing seal 11 attached thereto. In the rolling bearing 1, an inner ring 2 and an outer ring 3 rotate relative to each other through rolling elements 5 retained by a retainer 4. A lubricant 10 is sealed between the inner ring 2 and the outer ring 3. On both ends of the rolling elements 5 in the axial direction (left and right sides in the bearing width direction), bearing seals 11, 11 each having almost an annular shape as viewed from the front side are disposed so as to seal annular openings (ring-shaped openings) A, A at both the ends in the axial direction between the inner ring 2 and the outer ring 3.

The lubricant is a silicone oil-based lubricant or a mineral oil-based lubricant, as described above. The lubricant may be a liquid lubricating oil, or a semi-solid or solid grease, but is preferably a grease. In the case of a grease, the base oil is silicone oil or mineral oil, and various thickeners and the like are contained. The thickener may be a known one, and examples of the thickener include metal soap such as lithium soap, and urea.

The bearing seal 11 may be a single shield type for sealing only one side of the rolling bearing 1 depending on a use location instead of a double shield type for sealing the annular openings A, A of the rolling bearing 1 on both sides as shown in FIG. 1. In other words, the bearing seal 11 is disposed on at least one of the annular openings A, A on the left and the right sides in the bearing width direction between the inner ring 2 and the outer ring 3 of the rolling bearing 1.

As shown in FIG. 2, in the bearing seal 11, an outer circumferential portion and an inner circumferential portion of an annular metal core metal 12 formed by a steel plate or the like are continuously covered by an elastic member 13 described above by, for example, vulcanization adhesion, and the inner circumferential side end portion of the elastic member 13 is formed into a seal lip 14, and the outer circumferential side end portion is formed into an outer diameter mounting portion 15. A contact lip (main lip) 14a on the inner side of the seal lip 14 in the axial direction is brought into pressure contact with a side wall surface 8 extending in the radial direction of the inner ring 2, and the lubricant 10 filled in the bearing 1 can thus be prevented from leaking, and foreign matter can also be prevented from entering from the outside. A non-contact lip (dust lip) 14b on the outer side of the seal lip 14 in the axial direction opposes the outer circumferential surface of the inner ring 2 on the outer side of an inner ring circumferential groove 6 extending in the circumferential direction as also called seal groove formed in the outer circumferential surface of the inner ring 2, with a small gap therebetween, and foreign matter can thus be inhibited from entering from the outside, by a labyrinth sealing effect.

In the embodiment shown in FIG. 2, a narrowed portion 16 is formed between an inner circumferential surface 12A of the core metal 12 and the seal lip 14 in the bearing seal 11, and the contact lip 14a of the seal lip 14 is brought into pressure contact with the side wall surface 8 of the inner ring 2 as described above in a state where the bearing seal 11 is attached to the outer ring 3. For the structure for such pressure contact, the shapes, the dimensions, the positions, and the like of the seal lip 14 and the narrowed portion 16 can be determined as appropriate according to a predetermined method so that centrifugal forces to be exerted on the contact lip 14a and the non-contact lip 14b during rotation of the outer ring 3 are almost equal to each other, in consideration of balance in lip position variation due to centrifugal force by rotation of the outer ring 3. The balance is thus considered to thereby prevent a state where tightening force of the contact lip 14a with respect to the side wall surface 8 is reduced, increasing a gap between the non-contact lip 14b and the inner ring 2 to cause dust to enter easily, or a state where the contact lip 14a is away from the side wall surface 8 and a gap is thus formed, to cause the lubricant 10 to leak, or to cause dust, water, or the like to enter from the outside. Furthermore, the seal lip 14 and the narrowed portion 16 are each an elastic member formed of a cured product of the above-described rubber composition. Accordingly, in a case where a predetermined lubricant is used, characteristics such as mechanical strength (tensile strength at break, tensile elongation at break, etc.) derived from the epichlorohydrin rubber are good, and hardness and wear resistance are also good. Therefore, preferable pressure contact between the contact lip 14a and the side wall surface 8 is continuously maintained in synergy with the structure of the seal lip 14, and lifespan of the rolling bearing can be inhibited from becoming short.

As shown in FIG. 2, it is preferable that the bearing seal 11 has a protrusion 17 protruding from the end surface 12A of the core metal 12 in the bearing inward direction, and a small gap is formed between the protrusion 17 and the end edge of the side wall surface 8, i.e., the end edge in the outer ring direction, and thus, the lubricant is inhibited from flowing in the contact lip 14a direction by a labyrinth effect.

As shown in FIG. 2, the outer diameter mounting portion 15 is fitted into an outer ring circumferential groove 7 formed in the inner circumferential surface of the outer ring 3, thereby positioning and fixing the bearing seal 11 relative to the bearing 1, and preventing foreign matter from entering from the outer diameter portion of the bearing seal 11. Furthermore, the outer diameter mounting portion 15 is also the elastic member formed of the cured product of the above-described rubber composition, so that adhesion between the outer diameter mounting portion 15 and the outer ring circumferential groove 7 can be preferably maintained, and foreign matter can thus be effectively prevented from entering.

In the present embodiment, the above-described elastic member is applied to the rolling bearing having a structure in which the contact lip 14a of the seal lip 14 is constantly in pressure contact with the side wall surface 8 of the inner ring 2. However, the present invention is not limited to such an embodiment. For example, the elastic member that is the vulcanizate of the above-described rubber composition can be applied also to an elastic member functioning as a contact seal to seal the rolling bearing in a case where the rotation speed of the outer ring is relatively low, and functioning as a non-contact seal even in a state where the seal lip is distant from the inner ring in a case where the rotation speed of the outer ring is relatively high, as described in Japanese Unexamined Patent Application Publication No. 2010-265968. Particularly, when the elastic member functions as a contact seal, the elastic member has good hardness and can exhibit good wear resistance.

### EXAMPLES

The elastic member that is applicable to a rolling bearing according to the embodiment of the present invention will be described below in detail.

### (Test Example 1): Examination for Oil Resistance to Silicone Oil-Based Lubricant and Mineral Oil-Based Lubricant

### <Preparation of Elastic Member>

100.0 parts by weight of epichlorohydrin rubber (manufactured by Zeon Corporation, Hydrin H75, CO), 1.8 parts by weight of a vulcanizing agent (manufactured by Sankyo Kasei Co., Ltd., ZISNET F, 2,4,6-trimercapto-s-triazine), 0.6 parts by weight of a vulcanization accelerator (manufactured by SUMITOMO CHEMICAL COMPANY, LIMITED, SOXINOL D-G, 1,3-diphenylguanidine), 1.0 part by weight of a dispersion improver (manufactured by Momentive, A-189, silane coupling agent, γ-mercaptopropyltrimethoxysilane), 30.0 parts by weight of a reinforcing material (TOSOH SILICA CORPORATION, Nipsil ER, silicon dioxide), and 60.0 parts by weight of modified clay (manufactured by BURGESS, BURGESS KE, silane-modified clay), were mixed and kneaded in an 8 inch open roll to obtain a rubber composition. The obtained rubber composition was used to perform primary vulcanization (150 to 180° C. for 10 to 15 minutes) and secondary vulcanization (150 to 180° C. for 1 to 10 hours), and the obtained product was formed into a sheet-like shape. Thus, a rubber sheet (rubber molded product, hereinafter, referred to as “elastic member”) having a thickness of 2 mm was obtained.

### <Tensile Test>

The obtained elastic member was used to measure tensile strength at break and elongation at break in accordance with JIS K 6251. The measurement results were respectively 14.2 MPa and 570%, and thus it was confirmed that the elastic member was suitable as an elastic member for rolling bearings.

### <Oil Resistance Test>

The obtained elastic member was used to measure, in advance, hardness (Shore A hardness) in accordance with JIS K 6253-3, and a volume in accordance with JIS K6258. Subsequently, the elastic member was immersed in a mineral oil-based lubricant, a silicone oil-based lubricant, or an ester oil-based lubricant at 150° C. for 72 hours. Thereafter, the hardness and the volume were measured in a similar manner, and hardness change (ΔShore A) and a volume change rate (ΔV) were measured according to the following equation, and the oil resistance was evaluated.

$$Δ Shore A = ( Shore A hardness after immersion in the lubricant ) - ( Shore A hardness before immersion in the lubricant )$$

$$Δ V ( \% ) = [ ( volume after immersion in the lubricant / volume before immersion in the lubricant ) - 1 ] \times 100$$

The evaluation criteria were as follows.

In a case where ΔShore A was-20 or more and 20 or less, the amount of wear was able to be reduced, and practical use is possible.

In a case where ΔV was-5% or more and 20% or less, change in the interference of the bearing seal was small, torque was stable, and practical use is possible.

Table 1 shows evaluation results and used lubricants. The manufacturers/distributors of the lubricants listed in Table 1 are as follows. Alvania S: Shell Lubricants Japan K.K., Raremax AF-I: KYODO YUSHI CO., LTD, G40M: Shin-Etsu Chemical Co, ltd., MOLYKOTE 44M: Toray Dow Corning Corp., HQ72-102: NOK KLÜBER CO., LTD., Multemp SRL: KYODO YUSHI CO., LTD.

TABLE 1

| | | | Ex. 1 | Ex. 2 | Ex. 3 | Ex. 4 | Com. Ex. 1 | Com. Ex. 2 |
|---|---|---|---|---|---|---|---|---|
| Lubricant | Product name | | Alvania S | Raremax | G40M | MOLYKOTE | HQ72-102 | Multemp |
| (Grease) | | | | AF-I | | 44M | | SRL |
| | Component | Base oil | Mineral | Mineral | Silicone | Silicone oil | Ester oil | Ester oil |
| | | | oil | oil | oil | | | |
| | | Thickener | Lithium | Urea | Lithium | Lithium soap | Lithium | Urea |
| | | | soap | | soap | | soap | |

| | | | | | | |
|---|---|---|---|---|---|---|
| Hardness change [symbol] Shore A | +2 | +3 | +1 | +3 | −23 | −24 |
| volume change rate (72 hr) [symbol] [%] | +4.3 | +3.0 | −2.1 | −4.0 | +27.7 | +27.2 |
| Evaluation | Good | Good | Good | Good | Poor | Poor |

### (Test Example 2): Examination for Added Amount of Dispersion Improver

### <Preparation of Elastic Member>

Rubber sheets (rubber molded products, hereinafter, each referred to as “elastic member”) each having a thickness of 2 mm were prepared in the same manner as in Test Example 1 except that components were mixed at the respective blending ratios as shown in Table 2.

### <Wear Test>

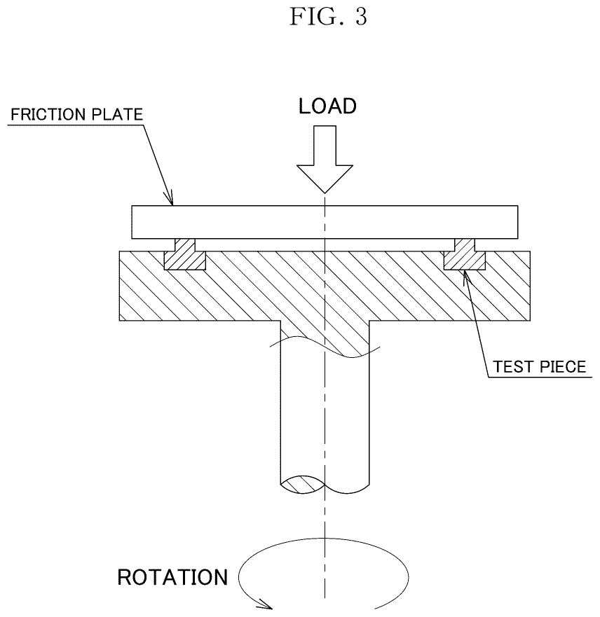

A test piece was produced by using each elastic member. FIG. 3 shows a wear resistance tester in which the test piece was rotated while a load was applied to the test piece from above by a friction plate. Then, the amount of wear (mm) of the test piece was checked. As the test condition, the load was 200 gf, the number of rotations was 10000 rpm, and the time was 15 minutes.

The evaluation criteria were as follows. “Poor” indicates that practical use is impossible.
Good: less than 0.10 mm
Fair: 0.10 mm or more and 0.30 mm or less
Poor: more than 0.30 mm

### <Dispersibility Test>

The obtained elastic member was used to cut out a JIS No. 3 dumbbell so that the length direction was the grain direction, in accordance with JIS K 6251. In the cut surfaces of the obtained dumbbell, images of two surfaces in a range corresponding to a distance between the mark lines (both sides in a range of 20 mm as the distance between mark lines, and 2 mm in the thickness direction) were taken by a digital microscope, the sizes of dispersed objects of which the images were being taken were measured, and the dispersibility was checked.

The evaluation criteria of the dispersibility were as follows. “Poor” indicates that practical use is impossible.

Good: Dispersed objects having sizes of 0.029 mm or less were merely observed while the images were taken.

Fair: One or more dispersed objects having sizes of more than 0.029 mm and 0.049 mm or less were observed while the images were taken.

Poor: One or more dispersed objects having sizes of more than 0.049 mm were observed while the images were taken.

Table 2 shows evaluation results.

TABLE 2

| | | Example | | | | | Comparative |
|---|---|---|---|---|---|---|---|
| | | 5 | 6 | 7 | 8 | 9 | example 3 |
| Rubber | Hydrin H75 | 100.0 | 100.0 | | 100.0 | 100.0 | 100.0 |
| component | Hydrin H55 | | | 100.0 | | | |
| Vulcanizing | ZISNET F | 1.8 | 1.8 | 1.8 | 1.8 | 1.8 | 1.8 |
| agent | | | | | | | |
| Vulcanization | SOXINOL | 0.6 | 0.6 | 0.6 | 0.6 | 0.6 | 0.6 |
| accelerator | D-G | | | | | | |
| Dispersion | A-189 | 0.5 | 1.0 | 1.0 | 3.0 | 5.0 | — |
| improver | | | | | | | |
| Reinforcing | Nipsil ER | 30.0 | 30.0 | 30.0 | 30.0 | 30.0 | 30.0 |
| material | | | | | | | |
| Modified | BURGESS | 60.0 | 60.0 | 60.0 | 60.0 | 60.0 | 60.0 |
| clay | KE | | | | | | |
| Wear test | Amount of | 0.12 | 0.06 | 0.08 | 0.06 | 0.1 | 0.32 |
| | wear [mm] | | | | | | |
| | Evaluation | fair | good | good | good | fair | poor |
| Dispersibility | Evaluation | fair | good | good | good | fair | poor |
| test | | | | | | | |

### (Test Example 3): Examination for Added Amount of Modified Clay

### <Preparation of Elastic Member>

Rubber sheets (rubber molded products, hereinafter, each referred to as “elastic member”) each having a thickness of 2 mm were prepared in the same manner as in Test Example 1 except that the components were mixed at the respective blending ratios as shown in Table 3.

### <Wear Test>

A wear test was performed and evaluation was made in the same manner as in Test Example 2.

### <Hardness Test>

The obtained elastic member was used to measure hardness (Shore A hardness) in accordance with JIS K 6253-3, and evaluation was carried out. The evaluation criteria were as follows. “Poor” indicates that practical use is impossible.

Excellent: Shore A hardness was 65 or more and 75 or less.

Good: Shore A hardness was 60 or more and less than 65.

Fair: Shore A hardness was more than 75 and 85 or less.

Poor: Shore A hardness was less than 60 or more than 85.

Table 3 shows evaluation results.

TABLE 3

| | | Example | | | | | | | | |
|---|---|---|---|---|---|---|---|---|---|---|
| | | 10 | 11 | 12 | 13 | 14 | 15 | 16 | 17 | 18 |
| Rubber | Hydrin | 100.0 | 100.0 | 100.0 | 100.0 | 100.0 | 100.0 | 100.0 | 100.0 | 100.0 |
| component | H75 | | | | | | | | | |
| Vulcanizing | ZISNET F | 1.8 | 1.8 | 1.8 | 1.8 | 1.8 | 1.8 | 1.8 | 1.8 | 1.8 |
| agent | | | | | | | | | | |
| Vulcanization | SOXINOL | 0.6 | 0.6 | 0.6 | 0.6 | 0.6 | 0.6 | 0.6 | 0.6 | 0.6 |
| accelerator | D-G | | | | | | | | | |
| Dispersion | A-189 | 1.0 | 1.0 | 1.0 | 1.0 | 1.0 | 1.0 | 1.0 | 1.0 | 1.0 |
| improver | | | | | | | | | | |
| Reinforcing | Nipsil ER | 30.0 | 30.0 | 30.0 | 30.0 | 30.0 | 30.0 | 30.0 | 30.0 | 30.0 |
| material | | | | | | | | | | |
| Modified clay | BURGESS | 10.0 | 20.0 | 30.0 | 40.0 | 50.0 | 60.0 | 70.0 | 80.0 | 90.0 |
| | KE | | | | | | | | | |
| Wear test | Amount of | 0.30 | 0.25 | 0.15 | 0.05 | 0.07 | 0.06 | 0.07 | 0.075 | 0.08 |
| | wear [mm] | | | | | | | | | |
| | Evaluation | fair | fair | fail | good | good | good | good | good | good |
| Hardness test | Shore A | 61 | 63 | 65 | 65 | 66 | 70 | 72 | 74 | 76 |
| | hardness | | | | | | | | | |
| | Evaluation | good | good | excel- | excel- | excel- | excel- | excel- | excel- | fair |
| | | | | lent | lent | lent | lent | lent | lent | |

### (Test Example 4): Examination for Added Amount of Reinforcing Material

### <Preparation of Elastic Member>

Rubber sheets (rubber molded products, elastic members) each having a thickness of 2 mm were prepared in the same manner as in Test Example 1 except that the components were mixed at the respective blending ratios as shown in Table 4.

### <Wear Test>

A wear test was performed and evaluation was carried out in the same manner as in Test Example 3.

### <Hardness Test>

A hardness test was performed and evaluation was carried out in the same manner as in Test Example 3.

Table 4 shows evaluation results.

TABLE 4

| | | Example | | | | |
|---|---|---|---|---|---|---|
| | | 19 | 20 | 21 | 22 | 23 |
| Rubber | Hydrin H75 | 100.0 | 100.0 | 100.0 | 100.0 | 100.0 |
| component | | | | | | |
| Vulcanizing | ZISNET F | 1.8 | 1.8 | 1.8 | 1.8 | 1.8 |
| agent | | | | | | |
| Vulcanization | SOXINOL | 0.6 | 0.6 | 0.6 | 0.6 | 0.6 |
| accelerator | D-G | | | | | |
| Dispersion | A-189 | 1.0 | 1.0 | 1.0 | 1.0 | 1.0 |
| improver | | | | | | |
| Reinforcing | Nipsil ER | 15.0 | 20.0 | 25.0 | 35.0 | 40.0 |
| material | | | | | | |
| Modified | BURGESS | 60.0 | 60.0 | 60.0 | 60.0 | 60.0 |
| clay | KE | | | | | |
| Wear test | Amount of | 0.30 | 0.25 | 0.10 | 0.07 | 0.05 |
| | wear [mm] | | | | | |
| | Evaluation | fair | fair | good | good | good |
| Hardness | Shore A | 62 | 62 | 65 | 75 | 80 |
| test | hardness | | | | | |
| | Evaluation | good | good | excel- | excel- | fair |
| | | | | lent | lent | |

In the elastic member containing the predetermined component, the rubber component may be the epichlorohydrin rubber. Even in such a case, if a silicone oil-based lubricant or a mineral oil-based lubricant is used, hardness change (Shore A hardness) and a volume change rate are smaller than a case in which an ester oil-based lubricant is used, and the elastic member is applicable to a rolling bearing, according to Table 1. According to Table 2, in a case where the elastic member contains the dispersion improver, dispersibility of the reinforcing material and the modified clay is good, and wear resistance is at such a level that the elastic member can be practically applied to rolling bearings without problems. According to Tables 3 and 4, in a case where the elastic member contains the reinforcing material and the modified clay, wear resistance and hardness are at such a level that the elastic member can be practically applied to rolling bearings without problems. Therefore, according to Tables 1 to 4, a rolling bearing including the predetermined elastic member is preferable for use as rolling bearings in various applications, such as automobiles, when a silicone oil-based lubricant or a mineral oil-based lubricant is used as the lubricant.

### DESCRIPTION OF THE REFERENCE CHARACTERS

A annular opening
1 rolling bearing
2 inner ring
3 outer ring
4 retainer
5 rolling element
6 inner ring circumferential groove
7 outer ring circumferential groove
8 side wall surface
9 outer circumferential surface
10 lubricant (grease)
11 bearing seal
12 core metal
12A inner circumferential surface
13 elastic member
14 seal lip
14a contact lip
14b non-contact lip (dust lip)
15 outer diameter mounting portion
16 narrowed portion
17 protrusion

1. A rolling bearing comprising:
an inner ring;
an outer ring;
rolling elements interposed between the inner ring and the outer ring; and
an elastic member provided in at least one of openings on both ends in an axial direction of the inner ring and the outer ring, and seals a lubricant around each of the rolling elements, wherein
the lubricant is one of a silicone oil-based lubricant and a mineral oil-based lubricant, and
the elastic member is a vulcanizate of a rubber composition containing epichlorohydrin rubber, a dispersion improver, a reinforcing material, and modified clay.

2. The rolling bearing according to claim 1, wherein
the rubber composition contains 1.0 to 3.0 parts by weight of the dispersion improver, 25 to 35 parts by weight of the reinforcing material, and 40 to 80 parts by weight of the modified clay, with respect to 100 parts by weight of the epichlorohydrin rubber.

3. The rolling bearing according to claim 1, wherein
the dispersion improver is a coupling agent.

4. The rolling bearing according to claim 1, wherein
the reinforcing material is silica.

5. The rolling bearing according to claim 1, wherein
the modified clay is silane-modified clay that is a surface-treated product obtained by performing surface treatment on clay with a silane-based coupling agent.
